(19) United States
(12) Patent Application Publication
(10) Pub. No.: US 2006/0020897 A1
(43) Pub. Date: Jan. 26, 2006

(54) Method for showing a component on a user interface

(75) Inventor: Jing-Ling Li, Taipei City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/175,338

(22) Filed: Jul. 7, 2005

(30) Foreign Application Priority Data
Jul. 23, 2004 (TW) 093122189

(51) Int. Cl. G06F 3/00

(52) U.S. Cl. 715/746

(57) ABSTRACT

A method for showing a component on a user interface is disclosed. A style maker provides some style options, each style option including associated configurations. When constructing the component on the user interface, one of the style options is selected for showing the component. In this manner, the constructed component is distinctly displayed on the user interface responding to the respective event.

### BACKGROUND OF THE INVENTION

1. Field of the Invention

The present invention generally relates to a user interface, and more particularly to visually displaying components or icons on the user interface by utilizing a style maker tool.

2. Description of the Prior Art

Embedded systems with high video quality, such as digital versatile disc (DVD) player or recorder, gain increased popularity among consumers. The design of the application programs for these embedded systems follows the traditional approach used in designing the application for the computer. FIG. 1 shows a conventional structure of an application program 10. The application program 10 mainly includes a function program 101 and a user interface (UI) program 102. The function program 101 serves as the fundamental functioning portion that, for example, receives, analyzes, and outputs the data; and the user interface program 102 acts to communicate with users, and usually includes a layout unit (LYT) 1023, a configuration unit (CFG) 1024, and a control unit (CTL) 1022 for the components or icons to be displayed on the user interface.

The layout unit (or tool) 1023 decides where the component is disposed on the user interface; the configuration unit 1024 sets the visual effects responding to individual activating event; and the control unit 1022 governs how and what to respond to events, for example, by controlling the style and color in a normal/default state, the style and color before and after being activated by the event, and the style and color in a disable/dimmed state.

A graphic library is traditionally constructed to contain variety of components, which are then configured to fit their respective visual effect. The programmer makes efforts with the flow or algorithm to accomplish the function program 101 such as receiving, analyzing, and outputting the data; and then the programmer utilizes the components provided in the graphic library to communicate with the users to receive their commands or selections, and also to provide information to the users.

FIG. 2 shows an exemplary user interface (or graphical user interface) 201, on which variety of components, such as button 2011, spin button 2012, and cursor editor 2013, are served to communicate between the application program and the users. A button 2011 in general has four distinct states responding to respective activating events: a normal state with a projected background, a focus state with the projected background and a color change, a selected state with changed color and a depressed background, and a disable (or gray) state with dimmed/gray background. The spin button 2012 facilitates the variation of numerals, for example, by arrow keys, and thus the spin button 2012 in general has the following states: a normal state, a selected state, spin up state, spin down state, and a disable state. The cursor editor 2013 serves to receive input from the keyboard, and thus the cursor editor 2013 has the following states: a normal state, a selected state, an input receiving state, an inverted state where cursor appears as inverted, and a disable state. For each event or component state, there is at least one associated configuration that stylizes that component to a distinct visual effect. The style could be modified according to different product or application by different programmer. In addition to those buttons illustrate above, there are still other components or icons that could be used on the user interface, such as menu buttons, toggles, radio buttons, or label/image icons.

In designing the user interface, the application programmer begins with building a specific component in the graphic library, and then deciding the location of that specific component on the user interface in the layout unit. Consequently, the programmer configures to set the styles and colors of the specific component responding to distinct event in the configuration unit. Finally, in the control unit, the programmer manages the activation of the events and the response of the components responding to the events.

It is such a laborious work for the programmer to individually and repeatedly configure each and every component to be displayed on the user interface. For each component, the programmer needs to configure every state with respect to each activating event. It is apt to carelessly incur inconsistency or even errors by the programmer in such repeated and monotonous task. Such errors make the debugging burdensome and delay the time to market.

In order to overcome the disadvantages mentioned above, the present invention provides a scheme to relieve the burden of the programmer and to prevent the errors from occurring.

### SUMMARY OF THE INVENTION

In view of the foregoing, it is an object of the present invention to provide a style maker tool to simplify the configurations to the similar or distinct components, in which the programmer only needs to select one of available style options to accomplish setting the configurations of the components on the user interface.

According to the object, the present invention provides a method of setting a component to be displayed on a user interface, by providing some style options, each style option including associated configurations. Subsequently, one of the style options is selected such that the associated configurations are utilized for displaying the component corresponding to activating events.

### BRIEF DESCRIPTION OF THE DRAWINGS

FIG. 1 shows a conventional structure of an application program;

FIG. 2 shows an exemplary user interface;

FIG. 3 shows an exemplary user interface (UI) design according to one embodiment of the present invention;

FIG. 4 shows another exemplary user interface (UI) design according to the embodiment of the present invention;

FIG. 5 shows a further exemplary user interface (UI) design according to the embodiment of the present invention; and

FIG. 6 shows a further exemplary user interface (UI) design according to the embodiment of the present invention.

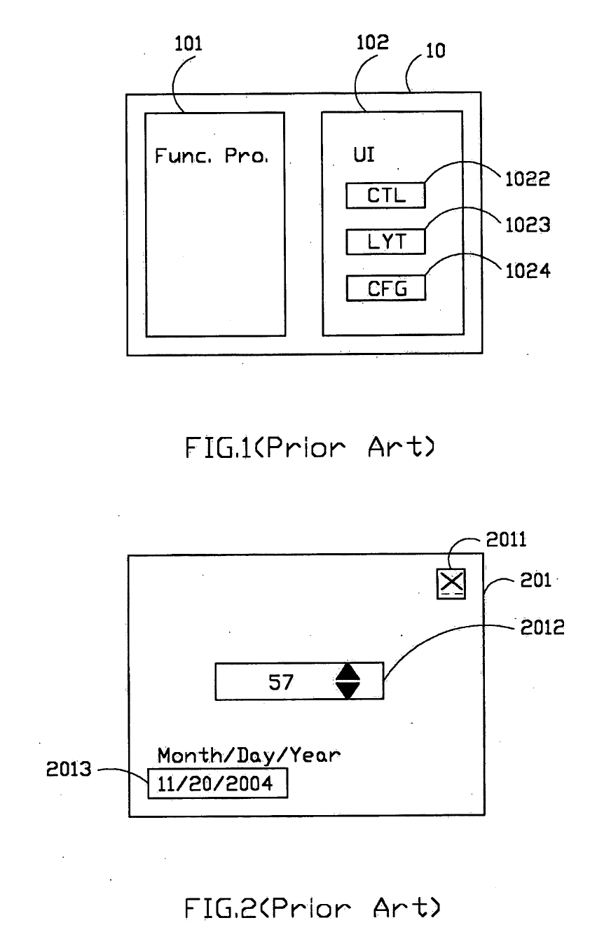

### DETAILED DESCRIPTION OF THE INVENTION

The detailed description of the present invention will be illustrated in the following. Composing and operational respects of user interface (UI) that are known to skilled artisans are principally described but, however, details are not entirely included in this specification for brevity. The accompanying figures, which are not drawn to scale, are used to facilitate the understanding the features of the present invention.

The present invention is directed to a setting method for displaying components, or icons, on a user interface (UI), especially on a graphical user interface (GUI). Specifically, a system style maker (or simply called style maker for short) provides some style options selectable by an application programmer or developer, and each style option has associated configurations that are pre-set corresponding to individual activating event. Accordingly, the programmer only needs, without others, to select one of available style options to accomplish designing and setting the configurations of the components (or icons) on the user interface.

As the style maker pre-sets the configurations of the to-be-displayed components (or icons) into some selectable style options, therefore, after the programmer has decided the layout of a component (or icon) by using a layout tool, he or she thereafter only needs to select one of the available style options and the associated configurations are automatically set. According to one feature of the present invention, a user (e.g., an application programmer) does not have to configure each component or icon himself/herself for the reason that the style maker has provided selectable style options with different configurations. In general, the configurations of the component or icon includes, but not limited to, color settings of the component, color settings of the letters/numerals in the component, response of the component due to an activating event. The visual appearance of the component in responding to an event includes, but not limited to, the color in a default or normal state, the color as the component being pointed and chosen, and the color after the component being clicked and selected.

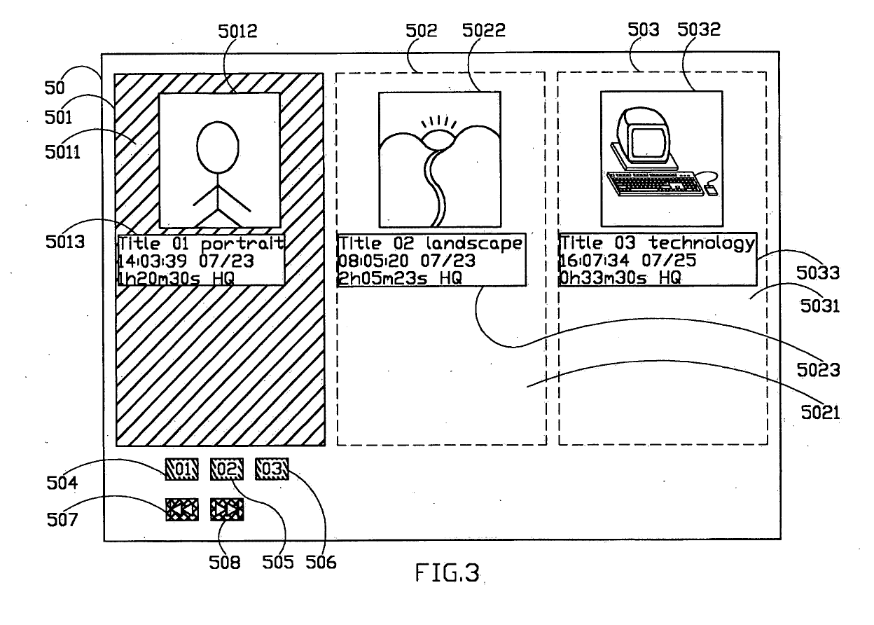

Moreover, the style maker categorizes the components as distinct style options, each having its associated configurations, wherein all style options are integrated into the style maker as a tool for the programmer to design and set the configurations of the components (or icons) on the user interface. It is appreciated that the setting of the configurations is not limited to those illustrated in the following embodiment. The present invention can be generally adapted to an interface design tool (i.e., style maker) which provides selectable style options that pre-set the visual appearance of the components. FIGS. 3 through 6 as will be described thereinafter demonstrate what the style options are and how the style options are utilized to design a user interface according to embodiments of the present invention.

FIG. 3 shows an exemplary user interface (UI) design 50 according to one embodiment of the present invention. On the UI 50 are three types of components. The buttons 501, 502, and 503 are categorized as one type of the style options, briefly as the first style option, which is configured, for example, as follows:
Set (No Background)
Set (Has Yellow_Focus)
Set (Label_Focus_Color, color1)
Set (Label_Normal_Color, color2)
   where the configurations listed above respectively denote the configuration that the background is not filled with any color, the configuration of a focus component that is highlighted with color yellow, the configuration of a focus component whose label (erg., letters or numerals) has a color represented by color1, and the configuration of normal/default component whose label has a color represented by color2. As shown in this example, the button 501 becomes a focus button, which is ready to receive input from the keyboard, and its background 5011 is highlighted with special color, yellow in this example and designated as hatching in the drawing; the letters/numerals of the label box 5013 have the color represented by color1; and the profile 5012 remains unchanged. With respect to the buttons 502 and 503, as they are not selected, these buttons remain in normal (or default) state and, accordingly, they are surrounded with dotted line and their respective background is without color; the letters/numerals of the label boxes 5023 and 5033 have the color represented by color2; and the profiles 5022 and 5032 remain unchanged. Accordingly, the configurations of the buttons 501, 502, and 503 of FIG. 3 could be set simply by calling the first style option.

Still referring to FIG. 3, buttons 504, 505, and 506 are categorized as another type of the style options, briefly as the second style option, on the user interface (UI) 50. These buttons are not selected, and thus stay in normal/default state, which is represented with another style (as designated as hatching) different from that of the first style option. The buttons 507 and 508 are categorized as the third style option, which is represented with another style as designated as cross-hatching.

For the example discussed above, the buttons 501, 504, and 507 have functions distinct from each other, and thus require different style options to stylize the visual effect. It is remarkably noted that the programmer only needs to select the first style option from the style maker, and the associated configurations are automatically set at the same time for all the similar buttons 501, 502, and 503. Likewise, the programmer only needs to select the second style option from the style maker, and the associated configurations are automatically set for all the similar buttons 504, 505, and 506; and the programmer only needs to select the third style option from the style maker, and the associated configurations are automatically set for all the similar buttons 507 and 508. Compared to the conventional techniques, the present invention omits the laborious effort to individually configure each and every component to be displayed on the user interface, and consequently avoids the errors carelessly incurred by a programmer in which similar buttons have inconsistent configurations. For example, the component 501 has been erroneously set a color different from that of the similar component 502 for the background in the same state, e.g., a normal state.

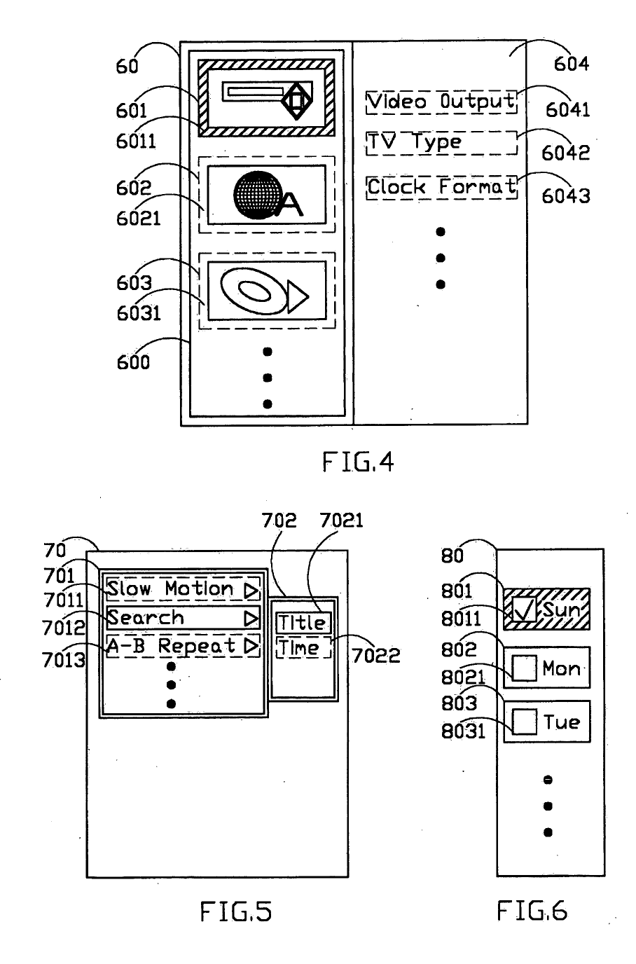

FIG. 4 shows another exemplary user interface (UI) design 60 according to the embodiment of the present invention. On the UI 60 is a menu 600, which includes menu buttons 601, 602, and 603. The menu-related style option of the style maker of the present invention provides variety of menu buttons selectable by the application programmer. Upon choosing one or more of the menu buttons, their associated configures are automatically set. In the example of FIG. 4, the menu 600 is surrounds with a solid line (or separator), and the menu buttons 601, 602, and 603 has their respective background. As the button 601 has been selected, it is highlighted with specific background and designated as hatching in the drawing; while other buttons 602 and 603 are not selected, and are thus surrounded with dotted line. It is notable that whenever a menu item is selected (the menu 601 in the example), its corresponding sub-menu item or items are displayed on the right hand side, with each sub-menu item being assigned its respective button such as the buttons 6041, 6042, and 6043 in the example. When another menu is selected, its sub-menu items, and only its sub-menu items, are promptly displayed. Accordingly, the configurations of the menu buttons could be set simply by calling the menu-related style option from the style maker.

FIG. 5 shows a further exemplary user interface (UI) design 70 according to the embodiment of the present invention, which illustrates another stylized visual effect as compared with that of FIG. 4. On the UI 70 is a menu 701, which includes menu buttons 7011, 7012, and 7013. These menu buttons 7011, 7012, and 7013 are altogether surrounded by a double solid line (or separator), and the selected button 7012 is highlighted with a solid boundary. Similar to FIG. 4, whenever a menu is selected (the menu 7012 in the example), its corresponding sub-menu items 702 are displayed on the right hand side, with each sub-menu item being assigned its respective button such as the buttons 7021 and 7022 in the example.

FIG. 6 shows a further exemplary user interface (UI) design 80 according to the embodiment of the present invention, which includes option buttons (sometimes called radio buttons) 801, 802, and 803. Each option button has a selection area (a square in the example) 8011, 8021, and 8031. When an option button is selected (the button 801 in the example), a selection symbol is displayed and the background of the button is highlighted as designated as hatching in the drawing.

As the style maker provides variety of selectable style options, the application programmer or developer only needs to select one of the available style options and the associated configurations are automatically set and visually displayed on the user interface, such as the button 501 or the menu button 601 in the figures. The programmer does not have to configure each component himself/herself, thereby structurally and modularly streamlining the programming.

Although specific embodiments have been illustrated and described, it will be appreciated by those skilled in the art that various modifications may be made without departing from the scope of the present invention, which is intended to be limited solely by the appended claims.

What is claimed is:

1. A method of setting a component to be displayed on a user interface, comprising:
providing a plurality of style options, each of said style options including a plurality of associated configurations; and
selecting one of said style options, such that the associated configurations are utilized for displaying the component corresponding to activating events.

2. The method according to claim 1, wherein said component is selected from the group consisting of a button, a spin button, a cursor editor, a menu, a menu button, a toggle, and a radio button.

3. The method according to claim 1, wherein each of said associated configurations respectively corresponds to one of said activating events, and each of said associated configurations possesses a visual effect.

4. A method of setting a component to be displayed on a user interface, comprising:
providing a style making tool, which includes a plurality of style options, each of said style options including a plurality of associated configurations; and
calling one of said style options, such that the component is distinctly displayed corresponding to activating events.

5. The method according to claim 4, wherein said component is selected from the group consisting of a button, a spin button, a cursor editor, a menu, a menu button, a toggle, and a radio button.

6. The method according to claim 4, wherein each of said associated configurations respectively corresponds to one of said activating events, and each of said associated configurations possesses a visual effect.
